(19) United States
(12) Patent Application Publication
(10) Pub. No.: US 2020/0398693 A1
(43) Pub. Date: Dec. 24, 2020

(54) MANAGEMENT SYSTEM, MANAGEMENT METHOD, POWER DEVICE, VEHICLE-MOUNTED DEVICE, AND MANAGEMENT SERVER

(71) Applicant: HONDA MOTOR CO., LTD., Tokyo (JP)

(72) Inventors: Tomohide Haraguchi, Wako-shi (JP); Shinichi Yokoyama, Wako-shi (JP); Takashi Sone, Wako-shi (JP); Keiichi Iguchi, Tokyo (JP)

(73) Assignee: HONDA MOTOR CO., LTD., Tokyo (JP)

(21) Appl. No.: 17/012,467

(22) Filed: Sep. 4, 2020

Related U.S. Application Data
(63) Continuation of application No. PCT/JP2018/045206, filed on Dec. 10, 2018.

(30) Foreign Application Priority Data
Mar. 15, 2018 (JP) 2018-048356

(51) Int. Cl. B60L 53/68; H02J 7/04; H02J 7/00; H02J 13/00; H01M 10/44

(52) U.S. Cl. CPC B60L 53/68; H02J 7/04; H02J 7/0013; H01M 2220/20; H02J 13/00006; H01M 10/44; H02J 7/0071; H02J 13/00002

(57) ABSTRACT

A management system for managing power for a battery mounted in a parked vehicle, includes a control unit configured to, out of power feeding from an electrical grid to the battery and power transmitting from the battery to the electrical grid, be capable of the power feeding at least; and an instruction unit configured to transmit an instruction for causing an electrical device of the vehicle relating to an environment for an occupant on the vehicle to start operating when a power management period for the battery has ended. The control unit feeds power that is consumed by the operation of the electrical device from the electrical grid to the battery.

This application is a Continuation of International Patent Application No. PCT/JP2018/045206, filed Dec. 10, 2018, which claims the benefit of Japanese Patent Application No. 2018-048356, filed Mar. 15, 2018, both of which are hereby incorporated by reference herein in their entirety.

### BACKGROUND OF THE INVENTION

### Field of the Invention

The present invention relates to a power management technique of a battery mounted in a vehicle.

### Description of the Related Art

A technique for improving an environment for an occupant on a vehicle before boarding is known. For example, Japanese Patent Laid-Open No. 2006-347295 proposes a technique that operates an air conditioner before boarding by remote operation of an occupant and improves comfort inside the vehicle from the time of boarding. An electrical device such as an air conditioner is driven mainly by power of a battery. Batteries mounted in electric vehicles and hybrid vehicles have been proposed for use in virtual power plants (VPPs) due to their large capacity. Japanese Patent Laid-Open No. 2011-050240 proposes a system for giving points to users of vehicles who have cooperated with a VPP.

In order to promote use of the VPP, it is necessary to ask for cooperation of users of vehicles, but it is necessary to motivate them. As in the system in Japanese Patent Laid-Open No. 2011-050240, the form of giving points can be one motivation, but when the points are subsequently changed to money or a service, it is difficult for the users to immediately experience satisfaction, and the motivation may be weak.

### SUMMARY OF THE INVENTION

An object of the present invention is to promote cooperation of vehicle users to the VPP.

According to an aspect of the present invention, there is provided a management system for managing power for a battery mounted in a parked vehicle, comprising:

a control unit configured to, out of power feeding from an electrical grid to the battery and power transmitting from the battery to the electrical grid, be capable of the power feeding at least; and

an instruction unit configured to transmit an instruction for causing an electrical device of the vehicle relating to an environment for an occupant on the vehicle to start operating when a power management period for the battery has ended,

wherein the control unit feeds power that is consumed by the operation of the electrical device from the electrical grid to the battery.

Further features of the present invention will become apparent from the following description of exemplary embodiments (with reference to the attached drawings).

### BRIEF DESCRIPTION OF THE DRAWINGS

FIG. 1 is a schematic diagram showing an example of a VPP to which a management system according to an embodiment of the present invention is applied.

FIG. 2 is a layout diagram of a parking facility to which the management system in FIG. 1 is applied.

FIG. 3 is a block diagram of a management server, a charging/discharging device, and a vehicle.

FIG. 4 is a flowchart showing a control example.

FIG. 5 is a diagram showing an example of management data.

FIG. 6 is a block diagram showing another configuration example of the charging/discharging device.

FIG. 7 is an explanatory diagram showing another example of an operation instruction.

### DESCRIPTION OF THE EMBODIMENTS

### First Embodiment

### Outline

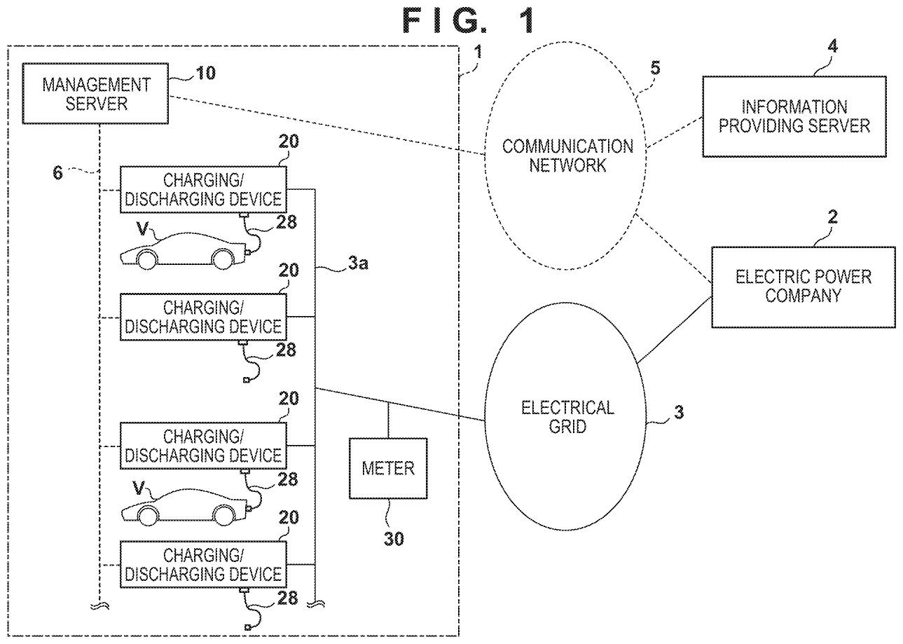

FIG. 1 is a schematic diagram showing an example of a VPP that includes a management system 1 according to an embodiment of the present invention. The VPP includes an electric power company 2, an electrical grid 3, and a communication network 6. The electric power company 2 is, for example, a system electric power company having a large-scale power plant, and can sell power to customers and purchase surplus power. The shown electric power company 2 is also used as a concept referring to equipment, such as power distribution equipment, power transmission equipment, and substation equipment, that constitutes, together with the electrical grid 3, an electric power system. Also, the shown electric power company 2 is used as a concept including a server that is connected to a communication network 5 (for example, the Internet) for data communication and manages selling and purchasing of power and the like. An information providing server 4 is a server that distributes various types of information (for example, weather forecast, traffic information, and power information) to the communication network 5.

The management system 1 is an aggregator that uses a battery of a vehicle V parked in a parking facility as an energy resource and manages the power on the VPP. The management system 1 includes a management server 10, a plurality of charging/discharging devices 20, and a meter 30. The management server 10 manages the management system 1 and determines a management mode of the battery. The management server 10 and the charging/discharging devices 20 are communicatively connected via a communication network 6. Communication by the communication network 6 is assumed to be wired communication, but may be wireless communication. The communication network 5 may be used as the communication network 6.

The charging/discharging devices 20 are connected to an electrical grid 3a included in the electrical grid 3, and are power devices that charge and discharge power between the battery of the vehicle V and the electrical grid 3. The meter 30 is a device that measures amounts of power transmission/reception between the charging/discharging devices 20 and the electrical grid 3, and measures an overall management result of power by the management system 1.

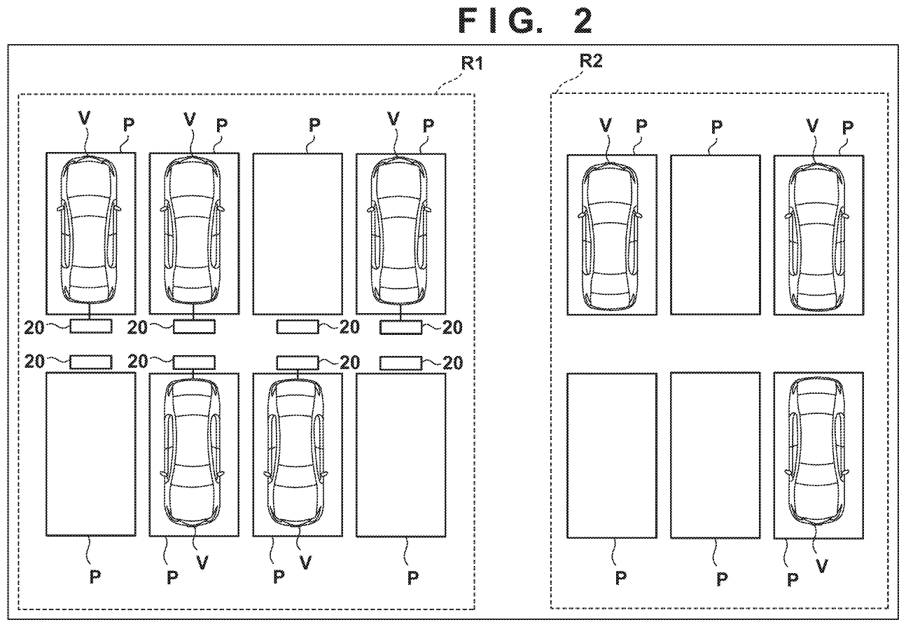

FIG. 2 is a diagram showing an example of a layout of the parking facility to which the management system 1 is applied. The parking facility includes a plurality of parking sections P and each parking section P has an area capable of parking one vehicle V. In the case of the example of FIG. 2, the plurality of parking sections P are divided into a VPP cooperation region R1 and a normal parking region R2. A charging/discharging device 20 is provided correspondingly in each parking section P of the VPP cooperation region R1, whereas no charging/discharging device 20 is provided in the normal parking region R2. Among users of vehicles V, users who can cooperate with the VPP can select the parking sections P in the VPP cooperation region R1, and users who do not want to cooperate with the VPP can select the parking sections P in the normal parking region R2. By devising the layout of the parking facility, users can easily express intention to cooperate with the VPP, and can avoid forcing users of vehicles V to perform a procedure for that when the users have no intention to cooperate.

From a viewpoint of managing the battery of the vehicle V in the VPP, it is advantageous that the vehicle V is parked for a relatively long time. Therefore, the parking facility can be adopted in places where parking for a relatively long time is expected, for example, in the vicinity of airports, sightseeing spots, and large-scale game facilities.

### Configuration of Management System

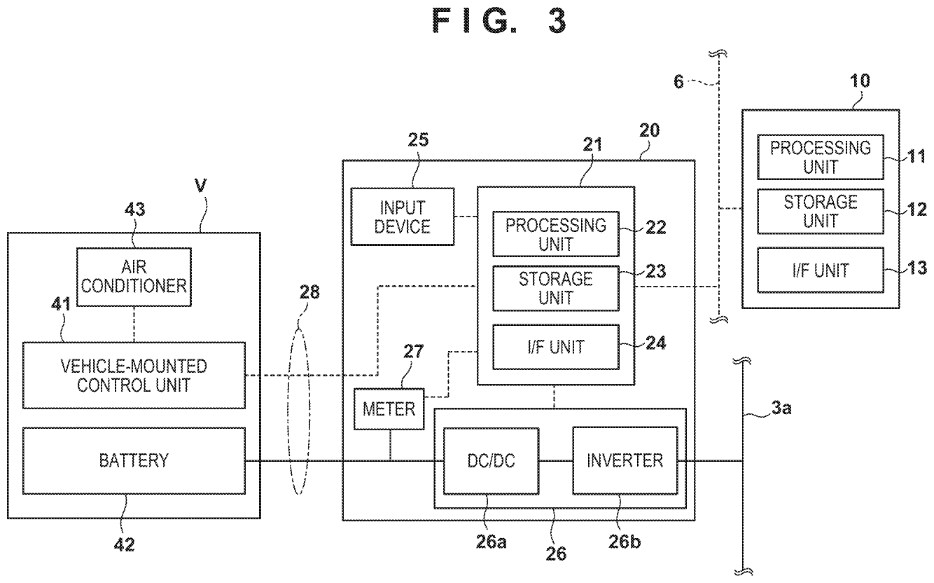

Configurations of the vehicle V and the management system 1 will be described with reference to FIG. 3. The figure is a block diagram of the management server 10, the charging/discharging device 20, and the vehicle V.

The vehicle V is, for example, an electric vehicle, a hybrid vehicle, or an electric motorcycle, and includes a battery 42 having a relatively large capacity. The battery 42 is a secondary battery such as a lithium ion battery, and may be a battery that supplies power to a traveling drive source (for example, a motor) of the vehicle V. Note that the traveling drive source may be a drive source that assists traveling of the vehicle V.

A vehicle-mounted control unit 41 is a vehicle-mounted device that controls the vehicle V. The vehicle-mounted control unit 41 is composed of a plurality of ECUs. Each ECU is in charge of a predetermined function among a plurality of functions of the vehicle V and controls a corresponding device. The functions can include, for example, traveling, braking, gear shifting, lighting, communication, display, and air conditioning. In the case of the embodiment, the vehicle V is provided with an air conditioner 43, and the vehicle-mounted control unit 41 controls the air conditioner 43. The air conditioner 43 is an example of an electrical device relating to an environment for an occupant on a vehicle, and adjusts room temperature inside the vehicle.

The management server 10 includes a processing unit 11, a storage unit 12, and an interface unit 13. The processing unit 11 is a processor represented by a CPU, and executes a program stored in the storage unit 12. The storage unit 12 is a storage device such as a RAM, a ROM, or a hard disk, and stores the program executed by the processing unit 11 and various types of data. The interface unit 13 is an interface that relays transmission and reception of signals between an external device and the processing unit 11. The interface unit 13 can include an input/output interface and a communication interface. The communication interface can include an interface for communication via the communication network 5 and an interface for communication via the communication network 6. The management server 10 can remotely control each charging/discharging device 20 via the communication network 6, and its geographical arrangement is not limited to the parking facility.

The charging/discharging device 20 includes a control unit 21, an input device 25, a charging/discharging circuit 26, a meter 27, and a cable 28. The cable 28 is a cable electrically connecting the vehicle V and the charging/discharging device 20, and in the case of the embodiment, the user of the vehicle V connects the cable 28 to the vehicle V. In the case of the embodiment, the cable 28 includes a communication line and a power line. The communication line is used for data communication between the vehicle-mounted control unit 41 and the control unit 21. The power line is used to charge and discharge the battery 42. In the embodiment, the data communication between the vehicle V and the charging/discharging device 20 is wired communication, but may be wireless communication. Furthermore, charging and discharging of the battery 42 is wired charging/discharging, but may be wireless charging/discharging.

The control unit 21 includes a processing unit 22, a storage unit 23, and an interface unit 24. The processing unit 22 is a processor represented by a CPU, and executes a program stored in the storage unit 23. The storage unit 23 is a storage device such as a RAM, a ROM, or a hard disk, and stores the program executed by the processing unit 22 and various types of data. The interface unit 24 is an interface that relays transmission and reception of signals between an external device and the processing unit 22. The interface unit 24 can include an input/output interface and a communication interface. The communication interface can include an interface for communication via the communication network 6.

The input device 25 is a device that receives an input of the user of the vehicle V, and is, for example, a touch panel. In the case of the embodiment, it is used for inputting information on parking (such as a parking condition) when the user of the vehicle V cooperates with the VPP.

The charging/discharging circuit 26 includes a bidirectional DC/DC converter 26a and a bidirectional inverter 26b. The bidirectional DC/DC converter 26a is electrically connected to the battery 42 via the cable 28 and converts the voltage of power discharged from the battery 42, a DC power source, and power fed from the bidirectional inverter 26b. The bidirectional inverter 26b converts AC power on the electrical grid 3a into DC power to feed power to the bidirectional DC/DC converter 26a, and converts DC power from the bidirectional DC/DC converter 26a into AC power to transmit power to the electrical grid 3a. The control unit 21 controls the charging/discharging circuit 26 to convert the AC power on the electrical grid 3a into DC power to feed (charge) the battery 42 with power, and converts the DC power of the battery 42 into AC power to transmit (discharge) power to the electrical grid 3a.

The meter 27 measures an amount of charge and an amount of discharge of the battery 42 to transmit them to the control unit 21. A management result of the battery 42 in the VPP can be identified by the meter 27.

### Processing Example

A processing example of the management system 1 will be described. In the embodiment, the air conditioner 43 is automatically operated before the vehicle V departs on condition that the user of the vehicle V has permitted the power management of the battery 42 to the VPP. The management system 1 side bears power necessary to operate the air conditioner 43. When the user of the vehicle V returns to the parked vehicle V and departs, the indoor environment is adjusted by the air conditioner 43, and so the user can depart comfortably. Such a pre-environment adjusting service allows the user of the vehicle V to be satisfied immediately after cooperation with the VPP, and can promote cooperation to the VPP.

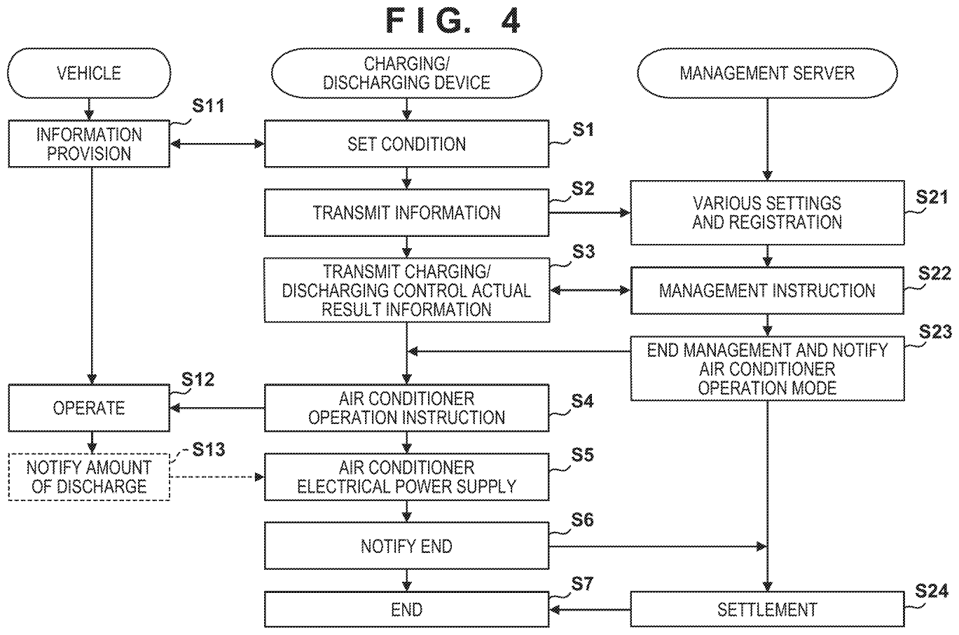

FIG. 4 shows a processing example of the vehicle-mounted control unit 41 of the vehicle V, the control unit 21 of the charging/discharging device 20, and the management server 10. First, when the vehicle V is parked in a parking section and the user connects the cable 28 of the charging/discharging device 20 to the vehicle V, communication is established between the vehicle-mounted control unit 41 and the control unit 21 of the charging/discharging device 20 via the cable 28.

In S1, the input device 25 receives a setting input of a usage condition from the user. Here, the user sets information on parking, such as scheduled departure time, confirmation of cooperation with the VPP, necessity of the pre-environment adjusting service, necessity of charging of the battery 42, and the degree of charging (such as full charge, 80%, or 50%). In response to a request for information provision to the vehicle V, the vehicle-mounted control unit 41 transmits certain information to the control unit 21 in S11. The transmitted information can include, for example, remaining amount information on the battery 42, an action schedule after departure (such as destination information), specification information on the air conditioner 43, or normal operation setting information (such as room temperature and air volume setting) on the air conditioner 43 set while the user is boarding. Such information can be used when managing the VPP or can be used for setting an operation mode of the air conditioner 43 in the pre-environment adjusting service. After setting in S1, the user can leave the vehicle V and then the parking facility.

In the embodiment, the information such as the scheduled departure time is input by the input device 25, but such information on parking may be input, for example, in such a way that the information on parking is input by the user of the vehicle V in advance on the vehicle V, and is notified from the vehicle V to the charging/discharging device 20 by communication between the vehicle V and the charging/discharging device 20 in S11.

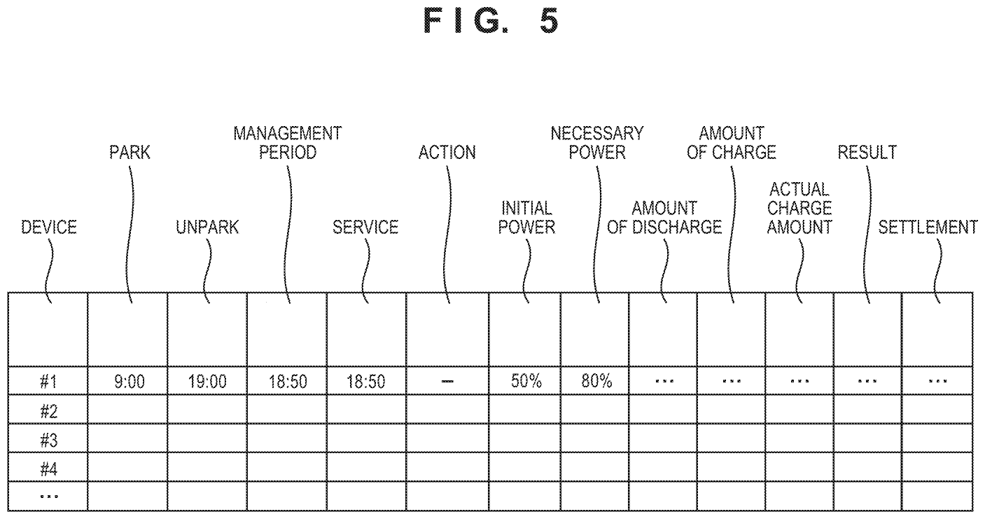

In S2, the control unit 21 transmits the information on parking of the vehicle set in S1 to the management server 10. The management server obtains the information by receiving it and updates a database for administration based on the obtained information. Specifically, with respect to the charging/discharging device 20, information on parking this time is registered and various settings are made. FIG. 5 indicates an example of information stored in the database.

In the example of FIG. 5, for each charging/discharging device 20 (#1, #2, . . . ), information including arrival, departure, management period, service, action, initial power, necessary power, discharge amount, charge amount, actual charge amount, result, and settlement is stored. The “arrival” is information on arrival time of the vehicle V. The “departure” is information on scheduled departure time of the vehicle V, and is set by the user. The “management period” is information on a power management period in which the battery 42 can be managed as a resource of the VPP, and is information on end time in the example of the figure. For the “management period,” for example, the management server 10 sets time obtained by subtracting a necessary time for the pre-environment adjusting service from the scheduled departure time. In the example of the figure, the necessary time for the pre-environment adjusting service is assumed to be ten minutes and the scheduled departure time is 19:00, so the end time of the management period is 18:50.

The “service” is information on a period of the pre-environment adjusting service, and is information on start time in the example of the figure. In the example of the figure, the start time is the same as the power management end time of the battery 42. The end time of the period of the pre-environment adjusting service can be the scheduled departure time. The “action” is information on an action schedule after departure and is, for example, information on a destination. The information is usable, for example, as information for responding to the case where the user's request for charging the battery 42 specifies power that allows the user to reach the destination, and a remaining amount of the battery 42 at the time of departure can also be set by using the information.

The “initial power” is information on a remaining amount of power stored in the battery 42 at the time of arrival, and is information (S11) obtained from the vehicle V. The “necessary power” is information on the remaining amount of the battery 42 at the time of departure, and is information by the user's input (S1). Cases are also assumed where the user may request to keep the current state at the time of arrival, and where the user may allow the remaining amount to be reduced by using the VPP, so the “necessary power” is information for responding to such demands of the user.

The “discharge amount” is a cumulative value of discharged power of the battery 42 during parking, and the “charge amount” is a cumulative value of charged power of the battery 42 during parking. These can be measured by the meter 27, and these pieces of information can be updated at any time during power management of the battery 42. The “actual charge amount” is a difference between the “charge amount” and the “discharge amount,” and a positive value indicates that the remaining amount of the battery 42 has increased from the time of arrival, and a negative value indicates that the remaining amount of the battery 42 has decreased from the time of arrival. The “actual result” is information on a power management actual result of the battery 42 in the VPP, and is a sum of the “charge amount” and the “discharge amount.” The “settlement” is consideration requested or paid to the user of the vehicle V at the time of departure, based on the “actual charge amount.” When the remaining amount of the battery 42 has increased, the consideration corresponding to the increase can be charged to the user, and when it has reduced, the consideration corresponding to its raw material can be paid to the user. When calculating the consideration, the consideration charged to the user can be reduced according to the “result,” or the consideration paid to the user can be increased.

The description returns to FIG. 4. After processing in S21, the management server 10 controls power management by including the battery 42 in the resource of the VPP based on updated information of the database. For example, the management server 10 selects charge, discharge, or keeping the current state of the battery 42 so as to meet the remaining amount of the battery 42 indicated in the “necessary power” at the time of power management end, and transmits its instruction to the control unit 21 in S22. The control unit 21 controls the charging/discharging circuit 26 based on the received instruction to charge/discharge the battery 42 from/to the electrical grid 3a. A measurement result of the meter 27 is transmitted to the management server 10, which in turn updates the database.

When management end time indicated in the “management period” arrives, in S23, the management server 10 notifies the control unit 21 of end of power management, and also notifies an operation mode of the air conditioner 43 to instruct the operation of the air conditioner 43, and to instruct the feeding power necessary for the operation of the air conditioner 43. The operation mode of the air conditioner 43 can include information such as operation start time, end time, room temperature setting, and air volume setting.

In S4, the control unit 21 instructs the vehicle-mounted control unit 41 to operate the air conditioner 43. At that time, the management server 10 specifies the operation mode notified in S23. The control unit 21 may instruct, at the operation start time, the vehicle-mounted control unit 41 to operate the air conditioner 43, or may reserve, before the operation start time, the vehicle-mounted control unit 41 to start operation at the operation start time.

In S12, the control unit 21 starts operation of the air conditioner 43. The operation of the air conditioner 43 allows the room temperature of the vehicle V to be adjusted before the user gets in. Since the management system 1 side bears power necessary to drive the air conditioner 43, the control unit 21 feeds power from the electrical grid 3a to the battery 42 by the charging/discharging circuit 26 in S5. The feeding amount of power may be a predetermined power amount, or may be a power amount estimated from the operation mode of the air conditioner 43. Alternatively, the vehicle-mounted control unit 41 notifies a discharge amount (power consumption of the air conditioner 43) of the battery 42 after the operation start of the air conditioner 43 (S13), and a power amount corresponding to the notified discharge amount may be fed.

When the scheduled departure time arrives or an operation end condition of the air conditioner 43 is established (such as a case where the room temperature has reached an appropriate temperature), the control unit 21 ends the power feeding for operating the air conditioner 43. In this case, the vehicle-mounted control unit 41 can also continue to operate the air conditioner 43 by using the charged power of the battery 42 in continuation. When the user of the vehicle V returns to the parking facility and instructs departure from the input device 25, the control unit 21 notifies the management server 10 of a use end in S6. The management server 10 performs a process relating to settlement in S24 and notifies the control unit 21 of its result. The control unit 21 performs an end process including the settlement process, and one time of parking use and power management is ended.

As described above, according to the embodiment, since the pre-environment adjusting service is provided for the user of the vehicle V who has cooperated with the VPP immediately before the departure, the user can be satisfied and cooperation to the VPP can be promoted. Since the pre-environment adjusting service is performed after power management of the battery 42 in the VPP, it is possible to clearly distinguish between the power management result of the battery 42 in the VPP and power provided to the vehicle V in the pre-environment adjusting service.

### Second Embodiment

In the first embodiment, the air conditioner 43 is exemplified as the electrical device of the vehicle V relating to an environment for an occupant on a vehicle, but the electrical device is not limited to this. In addition to an electrical device relating to temperature, such as seat heaters, steering wheel heaters, and grip heaters (motorcycle) other than air conditioners, the electrical device subject to the pre-environment adjusting service may be an electrical device relating to humidity and odor improvement, and an electrical device relating to improving the visibility of windows such as defoggers and wipers. Furthermore, multiple electrical devices may be operated.

The operation mode of the electrical device relating to the pre-environment adjusting service may be set in S23 according to a surrounding environment (such as temperature and humidity) of the vehicle V in the parking facility or the action schedule (“action” in FIG. 5) after departure. As the operation mode set according to the surrounding environment, for example, in the case of the air conditioner 43, room temperature setting and wind volume setting can be mentioned, which can be set to be cool in the summer and warm in the winter. When there is a large difference between the room temperature and outside temperature, the air volume may be increased. As the operation mode set according to the action schedule, for example, in the case of the air conditioner 43, the room temperature setting and the wind volume setting can be mentioned, the room temperature can be set slightly lower when the temperature of a destination or stopover is higher than that of the current position, and the room temperature can be set slightly higher when the temperature of the destination or stopover is lower than that of the current position. Weather information of each place can be obtained from the information providing server 4. It may be possible to increase user satisfaction by setting the operation mode according to the action schedule. When the destination is set, the operation mode may be set by prioritizing the situation of the destination over that of the current position, or the operation mode may be set by prioritizing the situation of the current position more when an expected arrival time to the destination is long, than when it is short.

The operation mode of the electrical device relating to the pre-environment adjusting service may be set in S23 according to the management result of the battery 42 in the VPP. As the management result is higher, an operation mode having a higher power consumption can be set, while as it is lower, an operation mode having a lower power consumption can be set. For example, in the case where the optimal temperature of the room temperature by the air conditioner 43 is 23 degrees (at the time of warming), the setting temperature is 23 degrees when the management result is at a certain level or above, whereas it is 21 degrees when the management result is below the certain level, and thereby power consumption may be reduced while ensuring some comfort. The number of electrical devices to be operated may be changed such that multiple electrical devices are operated when the management result is at the certain level or above, and one of electrical devices is operated when it is below the certain level. For the management result, information of the “result” in FIG. 5 may be used. It is possible to promote cooperation to the VPP by setting the operation mode of the electrical device with superiority or inferiority according to the management result of the battery 42.

The operation mode of the electrical device relating to the pre-environment adjusting service may be set in S23 according to a parking time zone of the vehicle V. Since contribution to the VPP is high during a time zone when power demand is high (such as daytime in the summer and morning in the winter), it is possible to promote cooperation to the VPP by giving preferential treatment by allowing an operation mode with high power consumption to be set when the user cooperates with the VPP by parking during such a time zone. The parking time zone can be identified from information of the “arrival” and “departure” in FIG. 5, or since the parking time zone here is related to power management in the VPP, the time zone may be defined by the “management period.”

In the pre-environment adjusting service, its instruction may be transmitted on condition that the scheduled parking time of the vehicle V exceeds a predetermined time (for example, several hours). Since the power management of the battery 42 in the VPP cannot be substantially achieved in the case of parking for a short time, parking for a longer time can be encouraged by making the pre-environment adjusting service unavailable. Cancellation of the pre-environment adjusting service may be performed at the setting stage of S21 or after confirmation of the actual management, the transmission of the instruction may be stopped in the processes of S23 and S4.

In the first embodiment, the pre-environment adjusting service is a free service in which the management system 1 side bears its power burden, but it may be a paid service with the consent of the user in which the price is discounted according to the power management of the battery 42 and the like. Alternatively, it may be a free service basically, but an additional consideration can be charged when the user instructs designation or the like of an operation mode of the electrical device by an option.

### Third Embodiment

It is also possible to interchange power of the batteries 42 among a plurality of vehicles V in the parking facility. For example, when there is a battery 42 that needs to be charged, the management server 10 instructs a charging/discharging device 20 connected with the battery 42 that needs to be charged to charge, and on the other hand, instructs a charging/discharging device 20 connected with another battery 42 to discharge (S22). Thereby, the battery 42 that needs to be charged can be charged by discharge of the other battery 42 existing inside the parking facility.

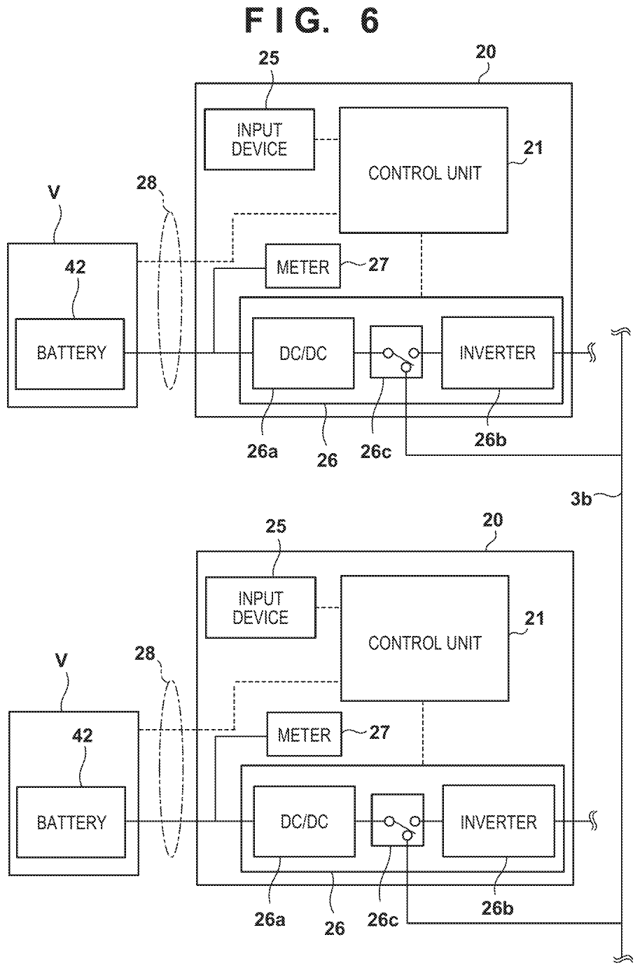

However, efficiency may be poor when the electrical grid 3a related to the VPP is used to transmit and receive power between the batteries 42 inside the parking facility. Consequently, an electrical grid closed in the parking facility is provided, and transmission and reception of power between the batteries 42 can be performed using the electrical grid. FIG. 6 is a block diagram showing an example of such a system.

In the example of the figure, the charging/discharging circuit 26 of the charging/discharging device 20 is provided with a switcher 26c between the bidirectional DC/DC converter 26a and the bidirectional inverter 26b. The switcher 26c switches, by control of the control unit 21, a connection mode between a VPP connection mode that connects the bidirectional DC/DC converter 26a and the inverter 26b and a local connection mode that connects the bidirectional DC/DC converter 26a and an electrical grid 3b. The electrical grid 3b is a wiring for DC power local to the parking facility. FIG. 6 exemplifies a state of the local connection mode.

When power is interchanged between the batteries 42, the power transmission and reception can be performed between the batteries 42 without passing through the electrical grid 3a related to the VPP by setting the switchers 26c corresponding to the target batteries 42 in the local connection mode. Since it does not pass through the inverter 26b, loss for it can be avoided. It becomes possible to manage power inside the parking facility in cases such as when the system power is tight. As a result, it is possible to more reliably respond to the user's request for charging the battery 42, and also it is possible to more reliably secure power necessary for the pre-environment adjusting service.

The management server 10 can set a combination of a charging side battery 42 and a discharging side battery 42, and instruct the control units 21 of the corresponding charging/discharging devices 20. The combination of the charging side and the discharging side may be 1:plural or plural:1 in addition to 1:1.

### Fourth Embodiment

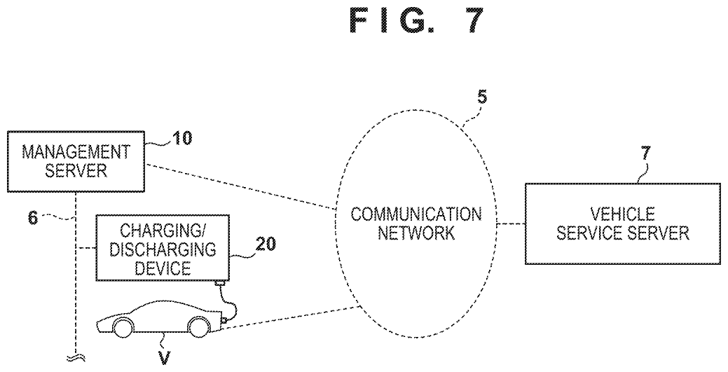

In the first embodiment, the operation instruction of the electrical device (air conditioner 43) relating to the pre-environment adjusting service is transmitted from the charging/discharging device 20 to the vehicle V, but the transmission source may be wireless transmission by the management server 10, or may be wireless transmission by a vehicle service server that is providing the vehicle V with a service. FIG. 7 is a configuration diagram of a system, indicating an example of wireless transmission by a vehicle service server 7.

The vehicle service server 7 is a server that, for example, distributes map information and traffic information to the vehicle V. When receiving, from a mobile terminal of the user of the vehicle V, an operation instruction of the air conditioner 43 before the user gets in, the vehicle service server 7 instructs the vehicle-mounted control unit 41 of the vehicle V to operate. Thereby, the vehicle V is pre-air conditioned by the air conditioner 43.

The vehicle service server 7 is preset by the user so as to, for example, also receive the operation instruction from the management server 10, or agreement and setting are made in advance between a manager of the vehicle service server 7 and a manager of the management server 10. Then, the management server 10 transmits the operation instruction of the electrical device relating to the pre-environment adjusting service to the vehicle service server 7 via the communication network 5. The operation instruction is given by, for example, specifying operation start time. The vehicle service server 7 transmits the operation instruction of the air conditioner 43 to the vehicle-mounted control unit 41 of the vehicle V according to the operation instruction, and the vehicle-mounted control unit 41 receives the operation instruction and operates the air conditioner 43 immediately or when the operation start time arrives.

Regarding the operation instruction of the electrical device relating to the pre-environment adjusting service, the operation start time may be changed by the user of the vehicle V by accessing the management server 10 from the mobile terminal, or the operation instruction may be triggered by the user's start instruction. In the latter case, for example, it is assumed that the power management period of the battery 42 is ended a predetermined time before the scheduled departure time (for example, 30 minutes before), and the start instruction may be received from the user between the scheduled departure time and the predetermined time.

### Other Embodiment

In the above embodiment, the pre-environment adjusting service is started the predetermined time before the scheduled departure time, and the power management period (particularly, the management end time) of the battery 42 is preset so as to secure the time. However, without presetting the power management period, the power management period of the battery 42 may be ended when the user inputs a departure instruction from the input device 25 or the mobile terminal, and the pre-environment adjusting service may be started. The power management period can be secured to the maximum in tune with actual departure.

In the above embodiment, the charging/discharging device 20 that performs both charging and discharging is exemplified as a power device that relays the battery of the vehicle V and the electrical grid 3, but such a power device may be a charging device that only charges, that is, only power feeding from the electrical grid 3a to the battery of the vehicle V. In this case, the control unit 21 only needs to be able to feed power from the electrical grid 3 to the vehicle V. In the case of this form, although an operation form of power in the power device is only charging (power feeding), even in this case, it is one form of power management, and cooperation to the VPP can be promoted.

The embodiments described above can be combined with each other, and contents described as part of each embodiment can be combined with another embodiment.

Part of processing performed by the management server 10 can be performed by the charging/discharging device 20 side. Conversely, part of processing performed by the charging/discharging device 20 can be performed by the management server 10.

In each embodiment described above, the management system 1 is a server-client type system including the management server 10 and the plurality of charging/discharging devices 20, but it may be a standalone type system configured by each charging/discharging device 20 performing the same processing as that of the management server 10. In this case, charging/discharging devices 20 having the functions of the management server 10 will form the management system 1.

### Summary of Embodiments

1. The management system of the above embodiment is

a management system (for example, 1) for managing a battery (for example, 42) mounted in a parked vehicle (for example, V), comprising:

a control unit (for example, 21 and S3) configured to, out of power feeding from an electrical grid (for example, 3a and 3b) to the battery and power transmitting from the battery to the electrical grid, be capable of the power feeding at least; and

an instruction unit (for example, 21, S4, 10, and FIG. 7) configured to transmit an instruction for causing an electrical device of the vehicle relating to an environment for an occupant on the vehicle to start operating when a power management period for the battery has ended,

wherein the control unit feeds power that is consumed by the operation of the electrical device from the electrical grid to the battery (for example, 21 and S5).

According to this embodiment, it is possible to provide a user of the vehicle who has cooperated with a VPP with a pre-environment adjusting service immediately before departure and therefore, the user can be satisfied. In this way, it is possible to promote cooperation to the VPP. Since the pre-environment adjusting service is performed after power management of the battery in the VPP, it is possible to clearly distinguish between a power management result of the battery in the VPP and power provided to the vehicle in the pre-environment adjusting service.

2. The management system of the above embodiment

further comprises a setting unit (for example, S21) configured to set a scheduled end time of the power management period and a scheduled operation start time of the electrical device based on a scheduled departure time of the vehicle.

According to this embodiment, it is possible to more reliably secure the power management period and an operation period of the electrical device and to achieve both management of the VPP and improvement of user satisfaction.

3. In the above embodiment,

the instruction unit transmits the instruction on condition that a scheduled parking time of the vehicle exceeds a predetermined time.

According to this embodiment, it is possible to encourage the user to park for a longer time and to promote cooperation to the VPP.

4. The management system of the above embodiment

further comprises a setting unit (for example, S23) for setting an operation mode of the electrical device according to a management result during the power management period.

According to this embodiment, it is possible to promote cooperation to the VPP.

5. The management system of the above embodiment

further comprises a setting unit (for example, S23) configured to set an operation mode of the electrical device according to a parking time zone of the vehicle.

According to this embodiment, it is possible to promote cooperation to the VPP.

6. The management system of the above embodiment

further comprises a setting unit (for example, S23) configured to set an operation mode of the electrical device according to an action schedule after departure of the vehicle.

According to this embodiment, it is possible to improve user satisfaction.

7. In the management system of the above embodiment,

the control unit is charging/discharging control unit capable of both of the power feeding and the power transmitting,

the management system further comprises a plurality of charging/discharging devices (for example, 20) corresponding to a plurality of respective parking spaces (for example, P),

each of the charging/discharging devices includes the charging/discharging control unit,

the charging/discharging control unit corresponding to a first parking space in the parking spaces transmits power from a battery of a first vehicle parked in the first parking space to the electrical grid,

the charging/discharging control unit corresponding to a second parking space in the parking spaces feeds power from the electrical grid to a battery of a second vehicle parked in the second parking space so as to charge the battery of the second vehicle by charged power in the battery of the first vehicle (for example, FIG. 6).

According to this embodiment, it is possible to interchange power of batteries between parked vehicles.

8. The management method of the above embodiment is a management method for managing a battery (for example, 42) mounted in a parked vehicle (for example, V), and comprises:

a management step (for example, S3 and S22) of, out of power feeding from an electrical grid (for example, 3a and 3b) to the battery and power transmitting from the battery to the electrical grid, performing the power feeding at least;

an instruction step (for example, S4 and FIG. 7) of transmitting an instruction for causing electrical device (for example, 43) of the vehicle relating to an environment for an occupant on the vehicle to start operating when the management step has ended, and

a power feeding step (for example, S5) of feeding power that is consumed by the operation of the electrical device from the electrical grid to the battery.

According to this embodiment, it is possible to provide the user of the vehicle who has cooperated with the VPP with the pre-environment adjusting service immediately before departure, and the user can be satisfied. In this way, it is possible to promote cooperation to the VPP. Since the pre-environment adjusting service is performed after power management of the battery in the VPP, it is possible to clearly distinguish between the power management result of the battery in the VPP and power provided to the vehicle in the pre-environment adjusting service.

9. The charging/discharging device of the above embodiment is a power device (for example, 20) provided correspondingly to a parking space (for example, P) in a parking facility, and comprises:

a control unit (for example, 21) configured to, out of power feeding from an electrical grid (for example, 3a and 3b) to a battery (for example, 42) mounted in a vehicle (for example, V) parked in the parking space and power transmitting from the battery to the electrical grid; and

an instruction unit (for example, 21 and S4) configured to transmit an instruction for causing an electrical device (for example, 43) of the vehicle relating to an environment for an occupant on the vehicle to start operating when a power management period for the battery has ended,

wherein the control unit feeds power that is consumed by the operation of the electrical device from the electrical grid to the battery (for example, 21 and S5).

According to this embodiment, it is possible to provide the user of the vehicle who has cooperated with the VPP with the pre-environment adjusting service immediately before departure, and the user can be satisfied. In this way, it is possible to promote cooperation to the VPP. Since the pre-environment adjusting service is performed after power management of the battery in the VPP, it is possible to clearly distinguish between the power management result of the battery in the VPP and power provided to the vehicle in the pre-environment adjusting service.

10. The vehicle-mounted device of the above embodiment is a vehicle-mounted device (for example, 41) capable of communicating with a management system (for example, 1) that manages a battery mounted in a parked vehicle, and comprises:

a notification unit (for example, S11) configured to notify the management system of information relating to parking of a vehicle mounting the vehicle-mounted device;

a reception unit (for example, S12) configured to receiving an operation command of an electrical device of the vehicle relating to an environment for an occupant on the vehicle; and

a control unit (for example, S12) configured to operate the electrical device based on the received operation command.

According to this embodiment, it is possible to provide a vehicle-mounted device suited to receive an operation service of the electrical device after management of the battery.

11. The management server of the above embodiment is a management server (for example, 10) for managing power for a battery mounted in a vehicle parked in a parking facility, comprises:

an acquisition unit (for example, 11, 13, S21) configured to acquire information relating to parking of the vehicle from a power device (for example, 20) which is provided in the parking facility and is connected with the vehicle;

a management instruction unit (for example, 11, 13, and S22) configured to instruct the power device to manage the battery mounted in the vehicle based on the information;

an operation instruction unit (for example, 11, 13, S23, and FIG. 7) configured to transmit an instruction for causing an electrical device of the vehicle relating to an environment for an occupant on the vehicle to start operating if a power management period for the battery has ended; and

a power feeding instruction unit (for example, 11, 13, and S23) configured to instruct the power device to feed power when operating the electrical device relating to the environment for an occupant on the vehicle.

According to this embodiment, it is possible to provide a user of a vehicle who has cooperated with the VPP with the pre-environment adjusting service immediately before departure, and the user can be satisfied. In this way, it is possible to promote cooperation to the VPP. Since the pre-environment adjusting service is performed after power management of the battery in the VPP, it is possible to clearly distinguish between the power management result of the battery in the VPP and power provided to the vehicle in the pre-environment adjusting service.

The present invention is not limited to the above embodiments and various changes and modifications can be made within the spirit and scope of the present invention. Therefore, to apprise the public of the scope of the present invention, the following claims are made.

What is claimed is:

1. A management system for managing power for a battery mounted in a parked vehicle, comprising:
a control unit configured to, out of power feeding from an electrical grid to the battery and power transmitting from the battery to the electrical grid, be capable of the power feeding at least; and
an instruction unit configured to transmit an instruction for causing an electrical device of the vehicle relating to an environment for an occupant on the vehicle to start operating when a power management period for the battery has ended,
wherein the control unit feeds power that is consumed by the operation of the electrical device from the electrical grid to the battery.

2. The management system according to claim 1, further comprising
a setting unit configured to set a scheduled end time of the power management period and a scheduled operation start time of the electrical device based on a scheduled departure time of the vehicle.

3. The management system according to claim 1, wherein the instruction unit transmits the instruction on condition that a scheduled parking time of the vehicle exceeds a predetermined time.

4. The management system according to claim 1, further comprising a setting unit configured to set an operation mode of the electrical device according to a management result during the power management period.

5. The management system according to claim 1, further comprising
a setting unit configured to set an operation mode of the electrical device according to a parking time zone of the vehicle.

6. The management system according to claim 1, further comprising
a setting unit configured to set an operation mode of the electrical device according to an action schedule after departure of the vehicle.

7. The management system according to claim 1, wherein
the control unit is charging/discharging control unit configured to be capable of both of the power feeding and the power transmitting,
the management system further comprises a plurality of charging/discharging devices corresponding to a plurality of respective parking spaces,
each of the charging/discharging devices includes the charging/discharging control unit, and
the charging/discharging control unit corresponding to a first parking space in the parking spaces transmits power from a battery of a first vehicle parked in the first parking space to the electrical grid,
the charging/discharging control unit corresponding to a second parking space in the parking spaces feeds power from the electrical grid to a battery of a second vehicle parked in the second parking space so as to charge the battery of the second vehicle by charged power in the battery of the first vehicle.

8. A management method of managing power for a battery mounted in a parked vehicle, the method comprising:
a management step of, out of power feeding from an electrical grid to the battery and power transmitting from the battery to the electrical grid, performing the power feeding at least;
an instruction step of transmitting an instruction for causing an electrical device of the vehicle relating to an environment for an occupant on the vehicle to start operating when the management step has ended; and
a power feeding step of feeding power that is consumed by the operation of the electrical device from the electrical grid to the battery.

9. A power device provided correspondingly to a parking space in a parking facility, comprising:
a control unit configured to, out of power feeding from an electrical grid to a battery mounted in a vehicle parked in the parking space and power transmitting from the battery to the electrical grid, be capable of the power feeding at least; and
an instruction unit configured to transmit an instruction for causing an electrical device of the vehicle relating to an environment for an occupant on the vehicle to start operating when a power management period for the battery has ended,
wherein the control unit feeds power that is consumed by the operation of the electrical device from the electrical grid to the battery.

10. A vehicle-mounted device capable of communicating with a management system that manages a battery mounted in a parked vehicle, the vehicle-mounted device comprises:
a notification unit configured to notify the management system of information relating to parking of a vehicle mounting the vehicle-mounted device;
a reception unit configured to receive an operation command of an electrical device of the vehicle relating to an environment for an occupant on the vehicle; and
a control unit configured to operate the electrical device based on the received operation command.

11. A management server for managing power for a battery mounted in a vehicle parked in a parking facility, the management server comprising:
an acquisition unit configured to acquire information relating to parking of the vehicle from a power device which is provided in the parking facility and is connected with the vehicle;
a management instruction unit configured to instruct the power device to manage the battery mounted in the vehicle based on the information;
an operation instruction unit configured to transmit an instruction for causing an electrical device of the vehicle relating to an environment for an occupant on the vehicle to start operating when a power management period for the battery has ended; and
a power feeding instruction unit configured to instruct the power device to feed power when operating the electrical device relating to an environment for an occupant on the vehicle.
